(19) United States
(12) Patent Application Publication
(10) Pub. No.: US 2015/0128387 A1
(43) Pub. Date: May 14, 2015

(54) SAFETY SPIKE

(71) Applicant: Peter Hvala, Melbourne (AU)

(72) Inventor: Peter Hvala, Melbourne (AU)

(21) Appl. No.: 14/401,850

(22) PCT Filed: Jul. 18, 2013
(86) PCT No.: PCT/AU2013/000797

§ 371 Date: Nov. 18, 2014

(30) Foreign Application Priority Data
May 21, 2012 (AU) 2012202986

(51) Int. Cl. B42F 1/00

(52) U.S. Cl. CPC B42F 1/00
USPC 24/67 P

(57) ABSTRACT

A safety spike device for retaining paper or other frangible material is discussed. The device has been developed to allow for persons to safely spike and retain paper or other frangible material. The spike has a downward facing spike tip and is able to move up and down relative to the base which is generally positioned on a table, counter or other flat surface.

### BACKGROUND OF THE INVENTION

This invention relates to improvements in devices for safely spiking and retaining paper or other frangible material.

The Safety Spike has been designed to safely spike and retain thin paper material such as receipts and scribbled notes. Conventional paper spikes utilise a rudimentary and generally fixed vertical projected spike that projects upwardly from a base or stand. In the home, office or restaurant environment this vertical spike configuration with the spike tip facing up presents an obvious safety hazard. In the future, workplace occupational health and safety guidelines may outlaw use of these objects all together. In fact, there are cases whereby individuals have been impaled by the vertical type paper spike, whether by accident or otherwise.

As an alternative there have been developed such devices as very large paper clips mounted on a similar base but these have had the problem of not being able to hold a sufficient volume of material, and a lack of reliability in operation. Other alternatives of using flexible spike members or moveable spike members about the fixed base go some way to minimizing the potential risk associated with a fixed and rigid vertical projecting spike.

The Safety Spike invention described in this document was developed in response to the identified need to find an elegant and simple solution to minimize the human risk associated with conventional vertical paper spikes. This intrinsic safety hazard of having a vertically projecting spike is overcome by the present invention by flipping the spike so that the spike tip points down rather than up. The device is designed to be portable, and generally it will be placed by the user on a desk, shelf, counter or similar flat surface. The device or components of which may be made from any suitable material such as plastic, metal or wood or a combination of such.

A variation to the basic device which may generally incorporate a single downward facing spike element will provide for a multiplicity of similar spike elements and generally, as such, have a larger product footprint; to accommodate the extra spike elements. This will allow for more paper holding capacity, and also, provide a means of ordering and organising receipts and paper across multiple spike elements.

### BRIEF DESCRIPTION OF THE DRAWINGS

To assist with understanding the invention, reference will now be made to the accompanying drawings which show non-limitative examples only of the preferred construction of the invention. Whilst there has been described in the description a preferred construction of a safety spike incorporating the principal features of the present invention, many variations or modifications in details of design or construction may be made without departing from the essential features of the invention.

FIG. 1a Illustrates an orthographic view of the product in accordance with an embodiment of the invention as claimed in claims 1 and 3 with the spike element being in the first position.

FIG. 1b Illustrates a top plan view of the product in accordance with an embodiment of the invention as claimed in claims 1 and 3 with the spike element being in the first position.

FIG. 1c is Illustrates a side view of the product in accordance with an embodiment of the invention as claimed in claims 1, 2 and 3 with the spike element being in the first position.

FIG. 1d Illustrates a front view of the product in accordance with an embodiment of the invention as claimed in claims 1, 2 and 3 with the spike element being in the first position.

FIG. 2a Illustrates an orthographic view of the product in accordance with an embodiment of the invention as claimed in claims 1, 2 and 3 with the spike element being in the first position.

FIG. 2b Illustrates an orthographic view of the product in accordance with an embodiment of the invention as claimed in claims 1, 2 and 3 with the spike element being in the second position, where the thin material is shown being pinched between the spike tip and the platform.

FIG. 2c Illustrates an orthographic view of the product in accordance with an embodiment of the invention as claimed in claims 1, 2 and 3 with the spike element being returned to the first position, with the spiked thin material retained.

FIG. 3 Illustrates an orthographic view of the product in accordance with an embodiment of the invention as claimed in claims 1, 2 and 5 with the spike element being in the first position.

FIG. 4 Illustrates an orthographic view of the product in accordance with an embodiment of the invention as claimed in claims 1, 2 and 6 with the spike element being in the first position.

FIG. 5 Illustrates an orthographic view of the product in accordance with an embodiment of the invention as claimed in claims 1, 2 and 7 with the spike element being in the first position.

### DESCRIPTION OF THE INVENTION

Throughout the following description specific details are set out to provide a more thorough understanding of the invention. However, the invention may be practiced without these particulars. In other instances, well know elements have not been shown or described in detail to avoid unnecessarily obscuring the present invention. Accordingly, the description and drawings are to be regarded in an illustrative, rather than a restrictive sense.

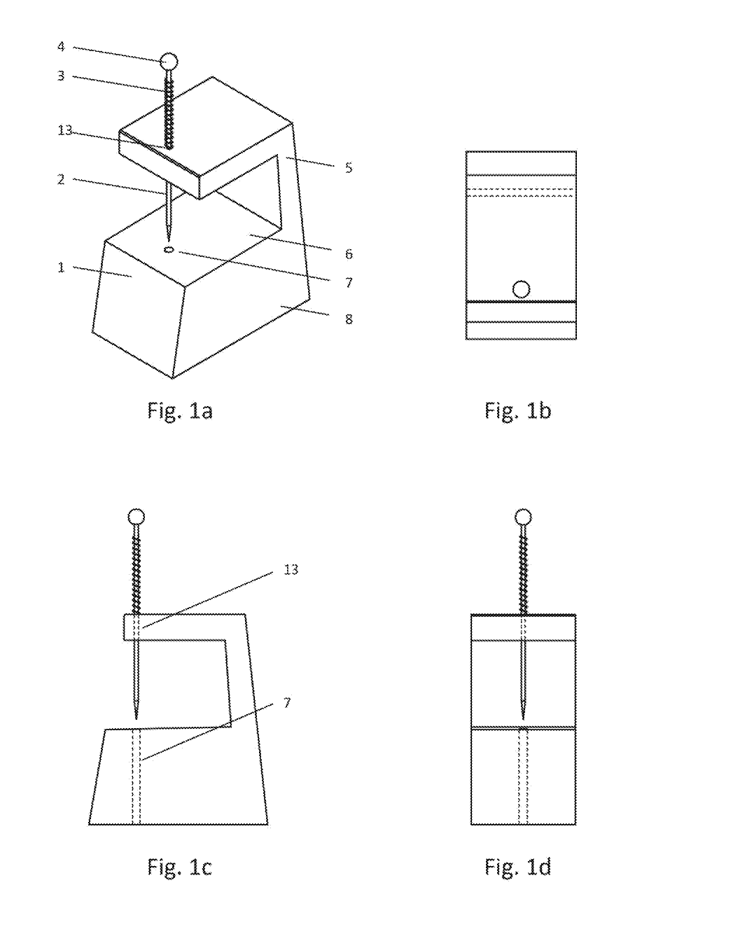

Referring to FIG. 1a and subsequent projected views of this being FIG. 1b, 1c and 1d, it can be seen a safety spike device for spiking and retaining thin paper or other frangible material such as post notes or receipts. According to the most general embodiment of this invention and embodiments thereof, the assembled device comprises principally a stand (1) and spike element (2) with a downward facing spike tip (12).

In a preferred embodiment, a spring (3) may be incorporated between the stand (1) and press knob (4) and acts mechanically to load the spike element against the stand.

Referring to FIGS. 1, 2, 3 and 4, a vertical member (5) projects outwardly from the stand base (8) and then, a lateral projection extends from this, forming the top portion which generally incorporates a spike guide hole (13). A platform (6) for placing paper or other frangible material before being spiked is incorporated above the stand base or may in fact be configured so as to be part of or integral to the stand base. The platform (6) incorporates a spike receiver feature such as a hole or collar (7).

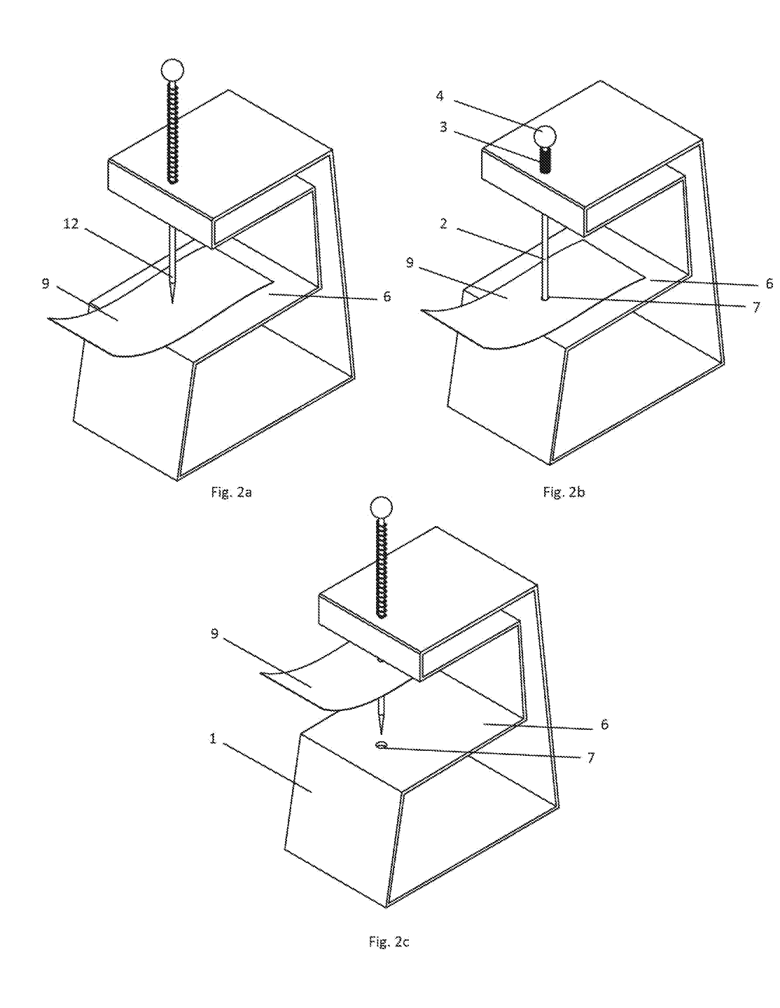

The general method of spiking the said material is represented consecutively across FIGS. 2a, 2b and 2c whereby a piece of thin paper or frangible material (9) is placed between the spike and a platform (FIG. 2a). Through applied action, the downward facing spike tip is able to move down and puncture through the said material and continue to move down and into or through the platform (FIG. 2b). In this configuration, the said material is forced up along the spike by the fixed, opposing nature of the static platform (FIG. 2c).

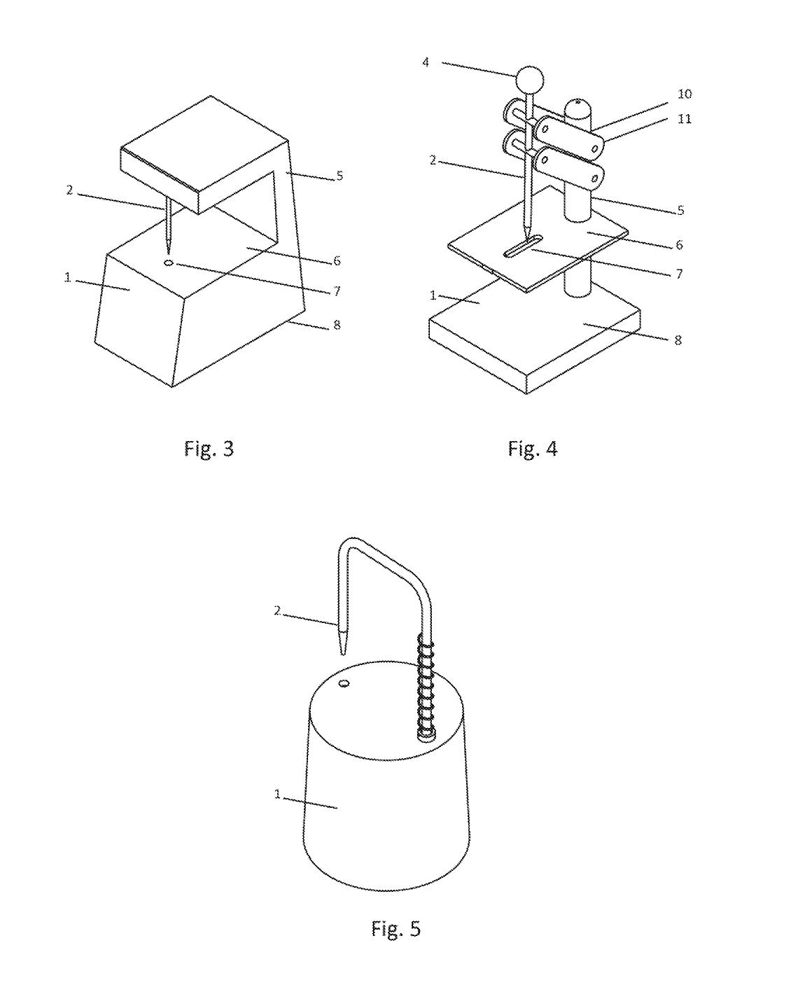

In yet another embodiment, referring to FIG. 3, the spike element (2) projects upwardly from the base (1) and is formed in such a way that the spike is bent back around, in a hook type configuration, to have the spike tip facing back downwards, towards the base. In this configuration, it is envisioned that the spike element will be spring loaded against the base.

In yet another embodiment, referring to FIG. 4, the spike element is rotatably connected to the stand through a multiplicity of movable four bar linkage type connections (10). The said rotatable connection is also known as a hinged one degree of freedom type joint (11). In this configuration, the stand represents a mechanically fixed link and the spike member is free to move about the stand in a relatively vertical fashion. This configuration endows constrained lateral movement of the downward facing spike member relative to the stand whilst allowing rotation of the linkage members about their hinged joints. In this configuration, it is envisioned that one or a multiplicity of linkages employed will be spring loaded against the stand or spike element.

1. A safety spike device for spiking and retaining flat material such as paper or other frangible material, comprising generally:
a) a stand with a base portion; and
b) an elongate spike element, with a sharpened tip of which the spike tip faces downward; the spike element being attached to the stand in such a way that it is free to move up and down along its longitudinal axis, relative to the ordinarily stationary stand base.

2. A safety spike device as described in claim 1 whereby said flat material can be placed between the said downward facing spike tip and a platform, itself having incorporated within it a spike receiver such as a hole, opening or collar; the said spike receiver being aligned axially and below the said spike element.

3. A safety spike device of claim 1 whereby the spike element assembles into a guide hole or collar that is incorporated into the top portion of the stand; the guide hole or collar itself being aligned axially above the spike receiver.

4. A spike element as claimed in claim 1 having a button or cap attached at the end opposite the spike tip.

5. A downward facing spike element as claimed in claim 1 whereby the spike element and the stand are rigidly attached.

6. The spike element of claim 1 whereby the spike element is rotatably connected to the stand through a multiplicity of movable four bar or similar type connections. The rotatable connection is known as a hinged one degree of freedom type joint.

7. A safety spike device of claim 1 whereby the spike element projects axially outwardly from the platform and is formed in such a way that the spike is bent or formed back around at an angle between 170 and 210 degrees so as to have the spike tip facing back downwards, towards the platform.

8. A safety spike device of claim 1 whereby multiplicities of downward facing spike elements are configured within the one device.

9. The method of claim 2 wherein material placed between the said spike tip and platform can be rested on the platform.

10. The method of claim 2 wherein the downward facing spike tip is mechanically able to move down and puncture through the said thin material and continue to move down through the thin material, into or through the platform. In this way configured, the said thin material is forced up along the spike by the opposing nature of the platform, being itself static.
